(19) United States
(12) Patent Application Publication
(10) Pub. No.: US 2014/0279715 A1
(43) Pub. Date: Sep. 18, 2014

(54) LIVE FOOD INGREDIENTS HARVESTED ON-DEMAND

(71) Applicant: Elie H. Gendloff, Oceanside, CA (US)

(72) Inventor: Elie H. Gendloff, Oceanside, CA (US)

(21) Appl. No.: 14/205,862

(22) Filed: Mar. 12, 2014

Related U.S. Application Data
(63) Continuation-in-part of application No. 14/145,972, filed on Jan. 1, 2014.
(60) Provisional application No. 61/800,686, filed on Mar. 15, 2013.

(51) Int. Cl. G06Q 90/00

(52) U.S. Cl. CPC G06Q 90/00
USPC 705/500

(57) ABSTRACT

Provided is a restaurant comprising a garden, where a food ingredient of an item served in the restaurant is removed from the garden after a customer of the restaurant orders the item, wherein the food ingredient is part of a plant grown in the garden. Also provided is a restaurant that comprises (a) a garden, and (b) a menu listing at least one item that has an ingredient that is part of a plant in the garden and is removed from the garden after the item is ordered, wherein the ingredient is part of a plant. Additionally provided is a method of selling a food by a food vendor. The method comprises selling the food growing in a container.

### CROSS-REFERENCE TO RELATED APPLICATION

This application is a continuation-in-part of application Ser. No. 14/145,972, filed Jan. 1 2014, which claims the benefit of U.S. Provisional Application No. 61/800,686, filed Mar. 15, 2013. Both applications are incorporated by reference herein in their entirety.

### BACKGROUND OF THE INVENTION

(1) Field of the Invention

The present invention generally relates to food service, food preparation, and food sourcing. More specifically, the invention is directed to the utilization of live food in a restaurant or food market. Examples include a restaurant that serves food items having the freshest possible ingredients, where the items are served within six hours of harvesting an ingredient in the item, and/or where the ingredient is harvested from a plant after a customer of the restaurant orders an item having the ingredient.

(2) Description of the Related Art

When a plant food ingredient such as a fruit or vegetable is harvested, the harvested ingredient responds to the harvesting injury within minutes (Reilly et al., 2003, Plant Mol. Biol. 53:669-685), leading to significant changes to the composition of that ingredient within hours of harvest (King, G. A. and S. C. Morris, 1994, J. Amer. Soc. Hort Sci. 119: 270-275; Afoakwa et al., 2001, Food chemistry 75:85-91; Ryoichi Masuda, pp. 92-102 in Vegetable Soybean: Research Needs for Production and Quality Improvement, S. Shanumgasandaram, Ed. 1991, ISBN: 92-9058-047-X; Degl'Innocenti et al., 2005, J. Agric. Food Chem. 53:9980-9984). For example, differences in broccoli toughness (“breaking force”) can occur within six hours of harvest (Baclayon et al., 2007, J. Biol. Sci. 7:614-619). Additionally, activity of the enzyme phenylalanine ammonia lyase (PAL) can change significantly within twelve hours of harvest (Bhowmik and Matsu, 2005, Z. Naturfursch. 60c:128-132). This change in PAL activity can exacerbate toughness, since PAL catalyzes the committed step in phenylpropanoid metabolism, which leads to lignin biosynthesis. Lignin is an important structural component in plant cell walls. Many flavor components of fruits and vegetables are also made through the phenylpropanoid pathway, indicating that changes in PAL likely lead to changes in flavor. Indeed, measurable changes in sensory panel scores have been demonstrated in soybeans within 10 hours of harvest (Masada, 1991).

The early compositional changes in harvested ingredients increase over time, in an irreversible process termed “senescence,” which eventually leads to cellular breakdown and death of the ingredient. For this reason, fresh ingredients are an essential component of nutritious, high quality food.

Even though food ingredients begin to deteriorate within hours of harvest, restaurants do not generally use food ingredients that have been harvested less than a day before utilization due to the logistical difficulty in obtaining fresher ingredients, and because the rapidity of the changes in food after harvest has not been generally appreciated. Even restaurants that have gardens on site generally harvest the ingredients at least several hours before the food is prepared. An exception is the Trellis Restaurant in Kirkland Wash., which seasonally offers a “Two-Hour Salad” with ingredients harvested within two hours of being served (heathmankirkl and [dot]com/trellis/kirkland-washington-restaurants [dot]aspx). Thus, most restaurant customers are unable to obtain a meal that uses food ingredients that are not altered somewhat from harvest.

There is therefore a need for a restaurant that utilizes food ingredients that are unchanged from harvest. The present invention addresses that need.

### BRIEF SUMMARY OF THE INVENTION

The present invention provides a restaurant and garden where the restaurant utilizes the freshest food ingredients possible. That is accomplished by harvesting a food ingredient within six hours of serving an item containing that ingredient, or harvesting a food ingredient after an item having the food ingredient is ordered by a restaurant customer.

Thus, in some embodiments, a restaurant comprising a garden is provided. In these embodiments, a food ingredient of an item served in the restaurant is removed from the garden after a customer of the restaurant orders the item. The food ingredient in these embodiments is part of a plant grown in the garden.

In other embodiments, a restaurant is provided that comprises (a) a garden, and (b) a menu listing at least one item that has an ingredient that is part of a plant in the garden and is removed from the garden after the item is ordered, wherein the inuredient is part of a plant.

In additional embodiments, a method of selling a food by a food vendor is provided. The method comprises selling the food growing in a container.

### DETAILED DESCRIPTION OF THE INVENTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

Provided herewith are institutions and methods for food provision and service that utilize live plants to allow consumers to consume freshly harvested ingredients from the plants.

In some embodiments, a restaurant comprising a garden is provided. In these embodiments, a food ingredient of an item served in the restaurant is removed from the garden after a customer of the restaurant orders the item. The food ingredient in these embodiments is part of a plant grown in the garden.

As used herein, a “restaurant” is a place where food and/or beverages are prepared and served to paying customers. The restaurant can be any size or design and can comprise, for example, a portable food cart, a farm stand, or a permanent structure. It can also be an independent business, or associated with another business, e.g., a hotel or office building. As used herein, a garden (for example a U-Pick strawberry farm where customers can eat the freshly picked strawberries in the field) is not a restaurant. However, a garden can have a restaurant, for example if a U-Pick strawberry farm had a restaurant on-site.

As used herein, a “customer” is a person that buys an item (food or drink) from the restaurant by ordering the item, then receiving the item from the restaurant after the item is prepared. A “diner” is a customer that is served an item to be consumed in the restaurant.

The item can be ordered at the restaurant or remotely, e.g., by telephone, facsimile or via the internet. The item can be taken out of the restaurant by the customer, delivered to the customer at an address away from the restaurant, or consumed in the restaurant. The item can have multiple ingredients, at least one of which is removed from the garden after a customer of the restaurant orders the item.

As used herein, a “garden” is an area having an ingredient that is purposefully cultivated to be used for food. Thus, ingredients that are foraged from uncultivated land are not considered herein to be cultivated in a garden.

The garden associated with the restaurant can grow ingredients of any type, including but not limited to a vegetable (e.g., a green vegetable or annual fruit such as tomato or cucumber), an herb, a mushroom, a spice, or a fruit of a tree, bush or perennial shrub. Nonlimiting examples of plants that may be grown in the garden include sweet corn, tomatoes, peppers, beans, potatoes, peanuts, garlic, kohlrabi, leek, carrots, cucumber, cantaloupes, melons, eggplant, pumpkin, squash, zucchini, onions, green onions, peas, beets, radishes, sweet potatoes, yams, jicama, cauliflower, Brussels sprouts, celery, horseradish, asparagus, turnips, chives, spinach, lettuce, arugula, cabbage, bok choy, mustard leaves, Swiss chard, turnip greens, bananas, plums, cherries, mulberries, pomegranates, apricots, apples, lemons, limes, oranges, peaches, avocados, mangos, guavas, chestnuts, dates, figs, almonds, walnuts, blueberries, raspberries, currants, elderberries, grapes, basil, chives, rosemary, thyme, cilantro, bay leaves, dill, fennel, marjoram, mint, oregano, parsley, sage, savory, tarragon, arugula, chervil, dill, spearmint, watercress, lemon balm, marjoram, oregano, rosemary, thyme, alfalfa sprouts, bean sprouts, quinoa sprouts, chia sprouts, white mushrooms, shiitake mushrooms, cremini mushrooms, oyster mushrooms, portabella mushrooms, morels and truffles.

The plant in these embodiments may be grown under any conditions, for example outdoors without any covering, in a greenhouse, in a lath house, under shading of any type, or under artificial illumination. An animal grown within the restaurant, e.g., a lobster growing in a tank in the restaurant, is not considered herein to be growing in the garden. However, in some embodiments, customers of the restaurant can dine in the garden. In various embodiments, the ingredient is not the meat of a mammal or poultry.

It is understood that, for various food items, only a portion of the ingredient that is harvested from the garden will be used in the item. For example, the core of an apple harvested from the garden might not be used in the food item having that ingredient.

The garden may be adjacent to the restaurant or a distance (e.g., 20 feet, 50 feet, 100 feet, 500 feet, 1000 feet, 2000 feet, one mile or more, or any distance in between) from the restaurant. The garden and restaurant need not be owned or controlled by the same entity. Having the garden adjacent to the restaurant is most convenient. In some embodiments, the garden grows plants for the restaurant and for other purposes, such as providing produce for farmer's markets.

In some embodiments, the garden provides growing food plants to food stores. Such plants can be produced in containers by the garden and packaged and shipped to grocers in a manner similar to ornamental growing plants, and put on the shelves of the grocery store as a food item. Anyone can thus enjoy the benefits of food that is harvested just before being eaten by purchasing these growing food plants from a grocer.

Thus, the present invention also provides a method of selling a food by a food vendor. The method comprises selling the food growing in a container. Also provided is a food vendor that sells food growing in a container. In some of these embodiments, the food is a vegetable, an herb, a spice, or a fruit of a tree, a bush or a perennial shrub.

As used herein, a food vendor includes an establishment that has a significant portion of its space, e.g., at least 10%, 20%, 30%, 40%, or 50%, devoted to displaying food for sale. Such establishments could include grocers, convenience stores, farmers markets, or retail department or discount stores with a food section, but does not include retailers such as hardware, garden supply, or home improvement stores that do not primarily sell food but may sell food items in a small section of the store, e.g., at the checkout counter.

As used herein, an ingredient is harvested from the garden when the ingredient is cut or removed from the garden such that it ceases to be growing. A fruit or vegetable that has fallen from a plant is considered harvested when the fruit or vegetable falls from the plant. In contrast, a plant growing in a container that is brought into a holding area inside or adjacent to the restaurant is considered herein to still be growing in the garden. Here, the plant may have been cultivated in a remote garden and transported to the restaurant in the container. In some Nonlimiting embodiments, the holding area is in a refrigerated room, outside, in a greenhouse, or in a lath house. The holding area may have artificial lights that promote photosynthesis and/or other light-promoting physiological processes.

As used herein, a plant growing in a container that is brought to a diner tableside is considered herein to be no longer part of the garden, but an ingredient from the plant is not harvested until the ingredient is removed from the growing plant.

It is contemplated that the ingredient is usually harvested by an employee of the restaurant and/or the garden. However, in some embodiments, the customer goes into the garden and harvests the ingredient, either alone or accompanied by a restaurant/garden employee. Either the customer or a restaurant employee may also harvest the ingredient tableside, according to the policy of the restaurant.

In other embodiments, the ingredient is harvested by a chef in the kitchen as the chef prepares the meal that includes that ingredient. For example, a chef can have several different container-grown plants at the chef's disposal, where ingredients are harvested from the plants during meal preparation.

If the customer is in the restaurant and prepared to dine when ordering an item having an ingredient that is harvested after ordering, the item would normally be served within an hour of the harvest of the ingredient. However, if the customer orders the item remotely, e.g., via telephone or the Internet, it is possible that the ingredient could be harvested many hours before the item is served. In order to assure freshness, it is preferred that the food ingredient is harvested within six hours of when the item is served to the customer.

In some of these embodiments, the food ingredient is harvested within three hours of when the item is served to the customer. This assures that the food ingredient is very fresh at serving, with minimal or no discernable changes (other than those caused in preparation, e.g., by cooking) from when it was harvested.

In additional embodiments, the food inuredient is harvested within one hour of when the item is served to the customer. This assures that the food ingredient is virtually unchanged at serving (other than by preparation) from when it was harvested.

In other embodiments, a restaurant is provided that comprises (a) a garden, and (b) a menu listing at least one item that has an ingredient that is part of a plant in the garden and is removed from the garden after the item is ordered. In these embodiments, the ingredient is part of a plant.

As used herein, a “menu” is a list of the items available for ordering in the restaurant. The menu can be presented in any manner, including but not limited to (a) being placed on a wall of a restaurant, (b) a hand-held paper or folio that can be separately given to each customer or left at a location away from the restaurant, (c) on the restaurant's web page on the Internet, or (d) a listing verbally provided by an employee of the restaurant or by a recording, e.g., by telephone or on the Internet.

In some embodiments, the restaurant further comprises a menu having at least one, two, three, four or five items listed therein that comprise an ingredient that is removed from the garden after the customer orders the item. In other embodiments, the menu lists, at least once a month over any two month, three month, four month, five month or six month period, at least two, three, four or five items that comprise an ingredient that is removed from the garden after the customer orders the item. In additional embodiments, at least 5%, 10%, 20%, 30%, 40%, 50%, 60%, 70%, 80%, 85%, 90%, 95%, or 100% of the time over any one, two, three, four, five or six calendar months, the menu lists at least one, two, three, four or five items that comprise an ingredient that is removed from the garden after the customer orders the item.

In various embodiments, the menu indicates that the ingredient will be removed from the garden after the item is ordered. In some of these embodiments, the menu further indicates that the item will be served within six hours, five hours, four hours, three hours, two hours, one hour, thirty minutes, fifteen minutes, five minutes, one minute, less than one minute, or any time in between, of the harvesting of the ingredient.

In various embodiments, the restaurant further provides a way for the customer to observe an employee of the restaurant remove an ingredient (e.g., an ingredient used in an item ordered by the customer) from the garden. Nonlimiting examples include (a) at least one closed circuit camera directed toward the garden and a monitor or other closed circuit feed (e.g., transmitted through a wireless transmitter to allow the customer to observe the removal on a computer or smart phone) allowing the customer to observe the camera feed, or (b) a window in the restaurant overlooking the garden.

In additional embodiments, an employee of the restaurant brings the removed ingredients to the customer before the food item having that ingredient is prepared. In some of these embodiments, the removed ingredients are subject to customer approval after inspection.

Also provided herewith is a restaurant comprising (a) a garden, and (b) a menu listing at least one, two, three, four or five items that have at least one ingredient that is in the garden and stating that the ingredient will be removed from the garden after the item is ordered. In these embodiments, the restaurant, garden, menu, ingredient, harvesting procedure, and item is as described and/or defined above.

In additional embodiments, a menu for any of the above-described restaurants is provided. In these embodiments, the menu lists at least one item that has any of the above-described ingredients, wherein the menu further states that the ingredient will be removed from the garden after the item is ordered. All aspects of these embodiments are as described above.

Also provided herewith is a method of serving a customer of any of the above-described restaurants. The method comprises removing an ingredient of an item ordered by a restaurant customer from a garden after the customer orders the item.

In some embodiments, the food ingredient is harvested within three hours of when the item is served to the customer. In other embodiments, the food inuredient is harvested within one hour of when the item is served to the customer.

Also provided is a restaurant that serves an ingredient to a diner before the ingredient is harvested. As used herein, a diner is “served” when the ingredient is brought to the diner, whether or not the ingredient is subsequently harvested and the item is prepared tableside by a restaurant employee.

In some embodiments, the ingredient is part of a plant growing in a container. For example, the restaurant may offer crackers with tomatoes, mozzarella cheese and basil, where the basil is served growing in a container such that a restaurant employee or the diner can cut (e.g., with scissors) or pick leaves off of the basil plant tableside to combine with the other ingredients. Nonlimiting examples of ingredients in these embodiments are a vegetable, an herb, a spice, a mushroom, and a fruit of a tree, bush or perennial herb. The ingredient may be utilized tableside in any dish, e.g., cilantro for a soup, mint for a hot or cold drink or a desert, chives for a baked potato, or parsley after the meal to promote fresh breath. In some embodiments, one or more growing plants are brought tableside and the diner or a restaurant employee prepares a substantial portion of a dish by harvesting ingredients from the plants. For example, lettuce, spinach, green onions, alfalfa sprouts, peas and/or tomatoes, growing in containers, can be brought tableside, where a restaurant employee harvests the ingredients to make a salad for the diner.

In these embodiments, the ingredient may also be harvested tableside by any relevant person, e.g., the diner, or any restaurant employee, e.g., a waiter. In alternative embodiments, the ingredient is bitten off the plant by the diner, e.g., a mint plant while drinking a mint julep, or a growing salad.

The plant can be in a container of any size, for example growing in a two inch container that may be put on the dining table, or a container of any larger size, for example a tree (e.g., apple, lemon, avocado, orange, grapefruit, etc.) growing in a 25-gallon pot with wheels that is rolled to the table.

After the ingredient is harvested, the plant can be returned to the restaurant or garden, or can be kept by the diner, as specified by restaurant policy.

In embodiments utilizing a plant growing in a container, the restaurant can utilize any plant having an edible plant part, growing in any suitable container. Preferably, the plant is growing in a medium that does not shed particles onto the dining table or kitchen. Several media that lack soil can be utilized in this regard, e.g., aggregates such as pumice, clay or rock pebbles, perlite, vermiculite, expanded clay pellets, porous glass media such as GROWSTONES®, or any combination. The plants can be grown in any environment, for example on a bench top or the ground, in a greenhouse, lath house or without shading, under natural or artificial lighting, or using any type of hydroponic system.

Also provided is a restaurant that, at least three days per week for at least three consecutive months, offers an item that has an ingredient that is harvested within six hours of the item being served to a customer (“six-hour harvested ingredient”). In some embodiments, the item is served to the customer within three hours of harvest of the ingredient. In other embodiments the item is served to the customer within one hour of harvest of the ingredient. In additional embodiments, the item is offered for at least four, five, six, seven, eight, nine, ten, eleven, or twelve consecutive months.

While the Trellis Restaurant in Kirkland Wash., has seasonally offered a “Two-Hour Salad” with ingredients harvested within two hours of being served, the restaurant described herein is distinguished by offering items having a six-hour harvested ingredient over an extended period, not just at certain times of the year. The invention restaurant thus provides a constant, not just seasonal, offering of items having a six-hour harvested ingredient.

In some of these embodiments, the ingredient is harvested before the customer orders the item. In other embodiments, the ingredient is harvested after the customer orders the item.

The practice of serving an item having an ingredient that is harvested within six hours or less of the item being served to a customer can be part time or full time at the restaurant. In some embodiments, the practice is at least five days a week. In other embodiments, the practice is less than five days a week. In additional embodiments, at least one item having an ingredient that is harvested within six hours of the item being served is offered substantially each day the restaurant is opened.

It is contemplated that the ingredient is usually harvested by an employee of the restaurant and/or the garden. However, in some embodiments, the customer goes into the garden and harvests the ingredient, either alone or accompanied by a restaurant/garden employee.

In some embodiments, the restaurant further comprises a menu having at least one item listed therein having an ingredient that is harvested within six hours of the item being served. The menu is as described previously. The menu can be present at the restaurant and/or accessible remotely (e.g., on the internet or by paper flyers) from the restaurant.

The menu can, some of the time or all of the time, have any number of items listed therein having an ingredient that is harvested within six hours of the item being served. For example, the menu can, at least once a month, have at least three items on the menu that comprise an ingredient that is harvested from the garden within six hours of the item being served. As other examples, the menu can, at least 30% of the time, 50% of the time, or 80% of the time, over one, two, three, four, five, six or more calendar months, have at least one item on the menu that comprises an ingredient that is harvested from the garden within six hours of the item being served.

In view of the above, it will be seen that several objectives of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. A restaurant comprising a garden, wherein a food ingredient of an item served in the restaurant is removed from the garden after a customer of the restaurant orders the item, wherein the food ingredient is part of a plant grown in the garden.

2. The restaurant of claim 1, further comprising a menu having at least one item listed therein that comprises an ingredient that is removed from the garden after the customer orders the item.

3. The restaurant of claim 1, further comprising a menu that has, at least once a month, at least three items on the menu that comprise an ingredient that is removed from the garden after the customer orders the item.

4. The restaurant of claim 1, wherein the plant is a vegetable, an herb, a mushroom, a spice, or a fruit of a tree, bush or perennial shrub.

5. The restaurant of claim 1, wherein the plant is sweet corn, tomato, pepper, bean, potato, peanut, garlic, kohlrabi, leek, carrot, cucumber, cantaloupe, melon, eggplant, pumpkin, squash, zucchini, onion, green onion, pea, beet, radish, sweet potato, yam, jicama, cauliflower, Brussels sprout, celery, horseradish, asparagus, turnip, chive, spinach, lettuce, arugula, cabbage, bok choy, mustard, Swiss chard, banana, plum, cherry, mulberry, pomegranate, apricot, apple, lemon, lime, orange, peach, avocado, mango, guava, chestnut, date, fig, almond, walnut, blueberry, raspberry, currant, elderberry, grape, basil, rosemary, thyme, cilantro, bay, dill, fennel, marjoram, mint, oregano, parsley, sage, savory, tarragon, arugula, chervil, dill, spearmint, watercress, lemon balm, marjoram, oregano, parsley, rosemary, sage, thyme, alfalfa sprouts, bean sprouts, quinoa sprouts, chia sprouts, white mushroom, shiitake mushroom, cremini mushroom, oyster mushroom, portabella mushroom, or truffle.

6. The restaurant of claim 1, wherein the plant is grown in a container.

7. The restaurant of claim 6, wherein the plant grown in the container is brought into a holding area inside or adjacent to the restaurant.

8. The restaurant of claim 6, wherein the plant grown in the container is brought to a chef of the restaurant, who harvests an ingredient from the plant and utilizes the ingredient in preparation of the item.

9. The restaurant of claim 6, wherein the plant grown in the container is brought to a diner in the restaurant.

10. The restaurant of claim 9, wherein a restaurant employee harvests an ingredient from the plant tableside and utilizes the ingredient in preparation of the item.

11. The restaurant of claim 9, wherein the diner harvests an ingredient from the plant and utilizes the ingredient in the item.

12. A restaurant comprising (a) a garden, and (b) a menu listing at least one item that has an ingredient that is part of a plant in the garden and is removed from the garden after the item is ordered, wherein the ingredient is part of a plant.

13. The restaurant of claim 12, wherein the menu lists at least one item comprising the ingredient that is part of the plant, wherein the plant is brought to a chef of the restaurant who harvests the ingredient from the plant while preparing the item.

14. The restaurant of claim 12, wherein the menu lists at least one item comprising the ingredient that is part of the plant, wherein the plant is brought to a diner and the inuredient is harvested tableside by a restaurant employee who prepares the item.

15. The restaurant of claim 12, wherein the menu lists at least one item comprising the ingredient that is part of the plant, wherein the plant is brought to a diner and the ingredient is harvested by the diner.

16. A method of serving the customer of the restaurant of claim 1, the method comprising harvesting the ingredient of the item ordered by the customer from the plant after the customer orders the item.

17. The method of claim 16, wherein the plant is brought to the restaurant growing in a container.

18. The method of claim 17, wherein the plant growing in the container is brought to a chef of the restaurant, who harvests an ingredient from the plant and utilizes the ingredient in preparation of the item.

19. The method of claim 17, wherein the plant growing in the container is brought to a diner in the restaurant.

20. A method of selling a food by a food vendor, the method comprising selling the food growing in a container.
